(19) United States
(12) Patent Application Publication
(10) Pub. No.: US 2026/0222307 A1
(43) Pub. Date: Jul. 30, 2026

(54) METHOD AND APPARATUS FOR SERVICE NETWORK RESILIENCE, ELECTRONIC DEVICE, AND STORAGE MEDIUM

(71) Applicant: Chengdu University of Technology, Chengdu City (CN)

(72) Inventors: Huyang Xu, Chengdu City (CN); Yuanchen Fang, Chengdu City (CN); Li Luo, Chengdu City (CN); Bin Lai, Chengdu City (CN); Jinlong Deng, Chengdu City (CN); Jiabei Hu, Chengdu City (CN)

(21) Appl. No.: 19/415,688

(22) Filed: Dec. 10, 2025

(30) Foreign Application Priority Data
Jan. 24, 2025 (CN) 202510116954.7

(51) Int. Cl. H04L 41/14; H04L 41/0826; H04L 41/12

(52) U.S. Cl. CPC H04L 41/145; H04L 41/0826; H04L 41/12

(57) ABSTRACT

A method and an apparatus for resilience of a service network, an electronic device, and a storage medium are provided. The disclosure can be implemented as follows. A corresponding digital twin can be constructed based on node states, link states and entity states of the service network. When the service network changes in structure, the digital twin is updated and potential paths are determined; with reference to ranking of enabling costs of the potential paths, a path enabling plan is updated; with the digital twin, a latest path enabling plan is transmitted to the service network. When performance of the service network is abnormal, the digital twin is updated, and initial simulation conditions are generated and service operation schemes are preliminarily screened. Then, time-series performance responses of respective operation schemes are obtained by simulating the schemes, so as to select an optimal service operation scheme from the operation schemes.

### CROSS-REFERENCE TO RELATED APPLICATIONS

This is a U.S. patent application which claims the priority and benefit of Chinese Patent Application Number 202510116954.7, filed on Jan. 24, 2025, the disclosure of which is incorporated herein by reference in its entirety.

### TECHNICAL FIELD

The disclosure relate to the technical field of computer network, in particular to a method and an apparatus for resilience of a service network, an electronic device, and a storage medium.

### BACKGROUND ART

A service network aims to provide a variety of services in an orderly manner. For example, cargo transportation relies on a sound transportation service network, data transmission relies on a stable communication service network, and patient treatment relies on a sound health service network. Therefore, the service network must be highly reliable and flexible.

The service network includes multiple nodes and multiple links. Incidents may cause node failure or link interruption, which in turn may result in performance degradation or damage of the service network. In this case, making reasonable decision on resilience of the service network can ensure stable operations and rapid recovery of the service network.

Digital twin can provide real-time state monitoring, timely anomaly detection, forward-looking state evaluation, and also support appropriate decision-making on resilience. However, the digital twin has brought new challenges that there is a real-time and two-way virtual-real mapping, and it is urgent to solve a lag problem in generating decision-making on resilience of the service network.

### SUMMARY

A method and an apparatus for resilience of a service network, an electronic device, and a storage medium are provided in the disclosure, which can solve at least one of above technical problems.

According to an aspect of the disclosure, there is provided a method for resilience of a service network, which includes:
constructing a corresponding digital twin in a service operation platform based on node states of respective nodes in the service network, link states of links among the respective nodes, and entity states of entities related to the respective nodes;
updating the digital twin based on the node states of the respective nodes in the service network, the link states of the links among the respective nodes, and the entity states of the entities related to the respective nodes in a case where the service network changes in structure;
determining a plurality of potentially available paths that have not served target demand and meet the target demand based on the updated digital twin;
determining third costs for respective potentially available paths based on first costs for respective nodes in the respective potentially available paths to be changed from failure to being available and second costs for respective links in the respective potentially available paths to be changed from interruption to being available;
determining a path enabling plan among the plurality of potentially available paths based on budget cost of the target demand; and
transmitting the path enabling plan to the service network corresponding to the digital twin, so that the service network provides corresponding services for the target demand according to the path enabling plan.

According to another aspect of the disclosure, there is provided an apparatus for resilience of a service network, which includes:
a digital twin construction module, configured to construct a corresponding digital twin in a service operation platform based on node states of respective nodes in the service network, link states of links among the respective nodes, and entity states of entities related to the respective nodes;
a first updating module, configured to update the digital twin based on the node states of the respective nodes in the service network, the link states of the links among the respective nodes, and the entity states of the entities related to the respective nodes in a case where the service network changes in structure;
a first path determination module, configured to determine a plurality of potentially available paths that have not served target demand and meet the target demand based on the updated digital twin;
a cost determination module, configured to determine third costs for respective potentially available paths based on first costs for respective nodes in the respective potentially available paths to be changed from failure to being available and second costs for respective links in the respective potentially available paths to be changed from interruption to being available;
a plan determination module, configured to determine a path enabling plan among the plurality of potentially available paths based on budget cost of the target demand; and
a plan transmission module, configured to transmit the path enabling plan to the service network corresponding to the digital twin, so that the service network provides corresponding services for the target demand according to the path enabling plan.

By adopting the technical scheme of the disclosure, the node states, the link states and a real-time state of the service network are monitored in real time through the digital twin. Moreover, when the service network changes in structure, the corresponding digital twin can be firstly updated based on the service network. Therefore, the plurality of potentially available paths that do not serve the target demand and meet the target demand are determined based on the digital twin; the third costs for respective potentially available paths are determined based on the first costs for the respective nodes in the respective potentially available paths to be changed from failure to being available and the second costs for the respective links in the respective potentially available paths to be changed from interruption to being available; a path enabling plan among the plurality of potentially available paths is determined based on the budget cost of the target demand; and finally, the path enabling plan is transmitted to the service network corresponding to the digital twin, so that the service network provides corresponding services for the target demand according to the path enabling plan. As such, the resilience of the service network can be improved.

It should be understood that content described in this section is not intended to identify key or essential features of the embodiments of the present disclosure, nor is it intended to limit scope of the present disclosure. Other features of the present disclosure will be readily understood from the following description.

### BRIEF DESCRIPTION OF THE DRAWINGS

The drawings are made for better understanding of this disclosure, and do not pose limitation on the present disclosure. In these figures:

FIG. 1 is a flowchart of a method for resilience of a service network according to an embodiment of the disclosure;

FIG. 2 is a structural block diagram of an apparatus for resilience of a service network according to an embodiment of the disclosure; and

FIG. 3 is a block diagram of an electronic device for implementing the method of the embodiment of the disclosure.

### DETAILED DESCRIPTION

Exemplary embodiments of the present disclosure are described below with reference to the drawings, with various details of the embodiments of the present disclosure being included to facilitate understanding, which should be considered as merely exemplary. Therefore, it should be realized by those skilled in the art that various changes and modifications can be made to the embodiments described herein without departing from scope of the present disclosure. Similarly, for clarity and conciseness, description of well-known functions and structures is omitted in the following description.

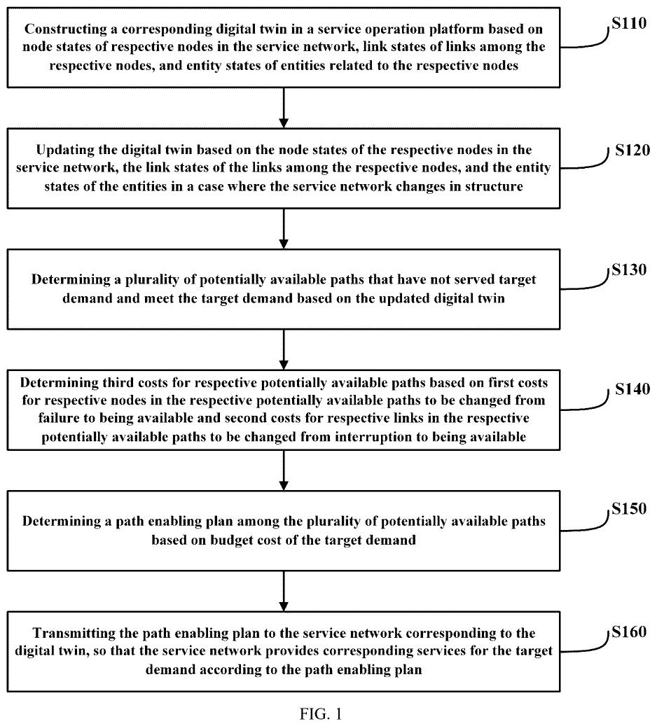

FIG. 1 is a flowchart of a method for resilience of a service network according to an embodiment of the disclosure.

As shown in FIG. 1, the method for resilience of the service network may include:

S110, constructing a corresponding digital twin in a service operation platform based on node states of respective nodes in the service network, link states of links among the respective nodes, and entity states of entities related to the respective nodes;

S120, updating the digital twin based on the node states of the respective nodes in the service network, the link states of the links among the respective nodes, and the entity states of the respective entities in a case where the service network changes in structure;

S130, determining a plurality of potentially available paths that have not served target demand and meet the target demand based on the updated digital twin;

S140, determining third costs for respective potentially available paths based on first costs for respective nodes in the respective potentially available paths to be changed from failure to being available and second costs for respective links in the respective potentially available paths to be changed from interruption to being available;

S150, determining a path enabling plan among the plurality of potentially available paths based on budget cost of the target demand; and

S160, transmitting the path enabling plan to the service network corresponding to the digital twin, so that the service network provides corresponding services for the target demand according to the path enabling plan.

Illustratively, this embodiment can be applied to a service operation platform.

Illustratively, the service network may be a structured service system, aiming at providing a variety of services in an orderly manner. For example, a transportation service network realizes delivery service of physical goods through inventory nodes and transportation lines. As another example, a communication service network is composed of nodes (such as base stations) and links (such as optical fibers) to provide various types of entity data transmission services. As another example, a health service network relies on nodes (such as hospitals and clinics) and links (such as referral paths and information links) to provide diagnosis and treatment services and health management services for entity patients.

In this embodiment, reliability of the service network relies on continuous availability of the nodes and the links, and its flexibility is embodied in dynamic adjustment and load distribution to be adapted to changing requirements. That is, the resilience aims to ensure rapid recovery of services after incidents and ensure the stable and efficient operation of the service network.

Illustratively, the nodes may include a source node, relay nodes, and a sink node. The source node represents a starting point of an entity, the sink node represents a destination point of the entity, and the relay nodes provide preset service.

Illustratively, the preset service is intend to change a state of the entity. For example, the goods may be varied in position and in classification status in the transportation service network; data integrity may be varied in the communication service network; and patients' health status may be varied in the health service network.

Illustratively, with aid of the Internet of Things, the node states of the respective nodes in the service network, the link states of the links among the respective nodes, and the entity states of the entities related to the respective nodes can be obtained. The node states, the link states and the entity states of the service network are input into the service operation platform in real time, so that the corresponding digital twin can be constructed.

Illustratively, the digital twin is a virtual mapping of the service network, which can reflect states of the nodes, the links and the entities of the service network in real time, identify existing available paths of the network, list potentially available paths, and provide initial simulation conditions and an optimal service operation scheme.

Illustratively, the potentially available path may be a path formed by a plurality of node links connected in sequence. The existing available paths can be paths connected by available links and in which the entity starts at the source node and ends at the sink node, experiences preset services and complete state changes.

Illustratively, if the service network changes, the digital twin also needs to be updated synchronously, which can keep the virtual-real mapping consistent.

Illustratively, a period from structural change of the service network to next structural change can be considered as a structural period.

Illustratively, changes in the structure of the service network may include changes in availability of the nodes and changes in the availability of the links. For example, a node changes from failure to being available or the node changes from being available to failure. As another example, a link changes from interrupted to available or from available to interrupted.

Illustratively, in each structural period, node availability and link availability of the service network are determined to update the corresponding digital twin. If a node available identifier is 0, then the node fails; and if the node availability identifier is 1, the node is available. If a link available identifier is 0, the link fails; and if the node availability identifier is 1, the link is available.

Illustratively, the digital twin identifies an existing path according to the node available identifier and the link available identifier.

It can be understood that if the node available identifier is changed to 1, an enabling cost exists. If the link available identifier is changed to 1, an enabling cost exists.

It can be understood that for all nodes with an available identifier of 1, it is necessary to rank their node enabling costs; and for all links with an available identifier of 1, it is necessary to rank their link enabling costs. According to the ranking of the node enabling costs and the ranking of link enabling costs, ranking of potential path enabling costs is obtained.

It can be understood that the service operation platform queries potential paths. With reference to the ranking of potential path enabling costs, a potential path with a lowest cost is included in the path enabling plan, so as to solve a problem that a preset series of service cannot be provided or cannot be provided insufficiently.

It can be understood that the path enabling plan includes an enabling queue. The enabling queue follows a first-in first-out principle. Solving a problem of a path which cannot provide the preset series of service has higher priority over solving a problem of a path which cannot provide the preset series of service insufficiently.

It can be understood that a potential path cannot repeatedly occur in the enabling queue.

Illustratively, constrained by path enabling cost and existing budget, the resilience of the service network has staged characteristics. By analogy, with reference to the structural period, the path enabling plan needs to be updated many times.

It can be understood that until the incident is resolved, there are nodes or links that have never been enabled.

Illustratively, the service network causes respective nodes to perceive whether they needs to be linked with each other according to the path enabling plan so as to form a required service sequence.

According to above embodiments, the node states, the link states and the real-time state of the service network are monitored in real time through the digital twin. Moreover, when the service network changes in structure, the corresponding digital twin can be firstly updated based on the service network. Therefore, the plurality of potentially available paths that do not serve the target demand and meet the target demand are determined based on the digital twin; the third costs for respective potentially available paths are determined based on the first costs for the respective nodes in the respective potentially available paths to be changed from failure to being available and the second costs for the respective links in the respective potentially available paths to be changed from interruption to being available; a path enabling plan among the plurality of potentially available paths is determined based on the budget cost of the target demand; and finally, the path enabling plan is transmitted to the service network corresponding to the digital twin, so that the service network provides corresponding services for the target demand according to the path enabling plan. As such, the resilience of the service network can be improved.

In an embodiment, the determining the path enabling plan among the plurality of potentially available paths based on the budget cost of the target demand includes: ranking the plurality of potentially available paths based on the third costs for the respective potentially available paths; calculating a total cost of a sequence of potentially available paths one by one from a potentially available path with a lowest cost based on a result of ranking the plurality of potentially available paths until the total cost of the sequence of potentially available paths is less than the budget cost, and determining the path enabling plan of the digital twin based on the sequence of potentially available path when a sum of the total cost of the sequence of potentially available paths and a third cost of a next potentially available path is greater than the budget cost.

Illustratively, the sequence of potentially available paths may include a plurality of potentially available paths in an ascending order of third costs.

Illustratively, when the total cost of the sequence of potentially available paths is less than the budget cost and the sum of the total cost of the sequence of potentially available paths and the third cost of the next potentially available path is greater than the budget cost, calculation of the total cost of the sequence of potentially available paths is stopped, and a current sequence of potentially available paths is used as the path enabling plan.

According to above embodiments, a plurality of potentially available paths meeting cost requirements and with a largest quantity can be accurately and quickly determined.

In an embodiment, the method further includes: updating the digital twin based on the node states of the respective nodes, the link states of respective node links, and the entity states of the respective entities in the service network in a case where node performance of the service network is abnormal; determining a plurality of existing available paths that have served the target demand and meet the target demand based on the updated digital twin; combining the plurality of existing available paths based on node loads of the respective nodes in the updated digital twin to obtain a plurality of sequences of existing available paths; performing a simulation test of service operation for respective sequences of existing available paths based on the updated digital twins to obtain response performance of the respective sequences of existing available paths; determining a target service operation scheme in the respective sequences of existing available paths based on the response performance of the respective sequences of existing available paths; and transmitting the target service operation scheme to the service network corresponding to the digital twin, so that the service network provides corresponding service for the target demand according to the target service operation scheme.

Illustratively, with aid of the digital twin, performance parameters of the current service network are extracted as the initial simulation conditions. The simulation conditions can include: performance parameters of available nodes, performance parameters of available links and load of existing paths.

The performance parameters relate to fixed or adjustable indexes and values needed for design, operation and optimization of the service network, which are used to support description, analysis and decision-making of the service network.

In this example, by means of the digital twin and with reference to the states of the nodes, the links and the entities, synchronous updating of the initial simulation conditions can be realized, which can ensure that the simulation is always based on a latest state of the service network, thus improving accuracy and effectiveness of prediction and deduction, and avoiding deviation of decision-making on resilience caused by virtual-real difference.

Illustratively, if the node load of the service network is higher than a threshold, it is determined that performance of the service network is abnormal. When abnormality occurs, with aid of the digital twin, the service operation platform can identify affected existing paths, find performance bottlenecks or resource competition, and then generate multiple service operation schemes.

It can be understood that the node load is quantitative description of an operation pressure and resource usage of respective nodes in the service network during operation. As a part of the service network, the node load directly affects operation efficiency and service quality of the service network. If the node load exceeds the threshold, it is determined that the node performance is abnormal.

Illustratively, the service operation scheme involves adjustment and distribution of the load of respective paths. That is, for a service sequence, it is necessary to balance entity traffic of different paths.

It can be understood that the service network contains multiple service sequences. Each of the service sequences may include one or more existing available paths. If the service sequence involves one or more existing paths, a corresponding service sequence can be provided within a structural period.

Illustratively, in a case where the corresponding service sequence can be provided, a screening criteria can be expressed as: there is a resource competition relationship between existing paths, but it is necessary to ensure that the service sequence has at least one existing path.

Illustratively, orthogonal experimental design can be adopted to reduce a number of experiments in a case of ensuring data adequacy, thus saving calculation time and resources and ensuring a scientific screening process.

According to above embodiments, in a case of abnormal node performance of the service network, the digital twin can be updated firstly, and then the plurality of sequences of existing available paths are simulated and tested respectively based on the updated digital twin, and an optimal target service operation scheme can be determined from the plurality of sequences of existing available paths by using simulated performance, thereby improving performance of the service network.

In an embodiment, the determining the target service operation scheme in the respective sequences of existing available paths based on the response performance of the respective sequences of existing available paths includes: determining quality losses of respective nodes in the respective sequences of existing available paths based on the response performance of the respective sequences of existing available paths; weighting and summing the quality losses of the respective nodes in the respective sequences of existing available paths respectively based on weights of the respective nodes in the respective sequences of existing available paths to obtain operation losses of the respective sequences of existing available paths; and determining the target service operation scheme in the respective sequences of existing available paths based on the operation losses of the respective sequences of existing available paths.

Illustratively, the response performance of the respective sequences of existing available paths can be:

$${y}_{i \vert k} ; i = 1 , 2 , … , m ; j = 1 , 2 , … , p ; k = 1 , 2 , … , n .$$

in which m indicates a total number of sequences of existing available paths, P indicates a number of nodes in a sequence of existing available paths, and k indicates a number of time sequence responses of a sequence of existing available paths.

Illustratively, a quality loss of a node in the sequences of existing available paths may be:

$${L}_{ij} = c ( \frac{1}{n} {\sum }_{k = 1}^{n} {y}_{ijk}^{2} ) ;$$

in which Lᵢⱼ indicates a quality loss of a j-th node of an i-th sequence of existing available paths, and c indicates a quality loss function.

Illustratively, the quality loss above can also be normalized.

Illustratively, with above normalization processing, weights of respective nodes in the sequence of existing available paths can be obtained.

Illustratively, an operational loss of a sequence of existing available paths may be:

$${Ω}_{i} = {w}_{1} {z}_{i 1} + {w}_{2} {z}_{i 2} + … + {w}_{p} {z}_{ip} ; i = 1 , 2 , … , m ;$$

in which Ωᵢ indicates an operation loss of an i-th sequence of existing available paths, w₁ to wₚ indicate weights of respective nodes in the i-th sequence of existing available paths, and zᵢ₁ to zᵢₚ indicate quality losses of the respective nodes in the i-th sequence of existing available paths.

According to above embodiments, operation losses of the respective sequences of existing available paths can be calculated, and a most economical target service operation scheme can be selected by using the operation losses.

In an embodiment, the method further includes: performing principal component analysis on respective nodes in an existing available path to obtain feature values of the respective nodes in the existing available path; and determining weights of the respective nodes in the existing available path based on feature values of the respective nodes in the existing available path.

Illustratively, the quality losses of the respective nodes can be normalized to obtain a normal distribution result, and the principal component analysis is performed on the normal distribution result to obtain the feature values of the respective nodes.

Illustratively, a ratio between a feature value of a node and a sum of feature values of all of nodes is taken as a weight of the node.

According to the above embodiments, the weights of the respective nodes can be calculated by the principal component analysis.

In an embodiment, the determining the target service operation scheme in the respective sequences of existing available paths based on the operation losses of the respective sequences of existing available paths includes: determining a sequence of existing available paths with a smallest operation loss among the respective sequences of existing available paths as the target service operation scheme, based on the operation losses of the respective sequences of existing available paths.

According to the above embodiments, the sequence of existing available paths with the smallest operation loss can be selected as the target service operation scheme.

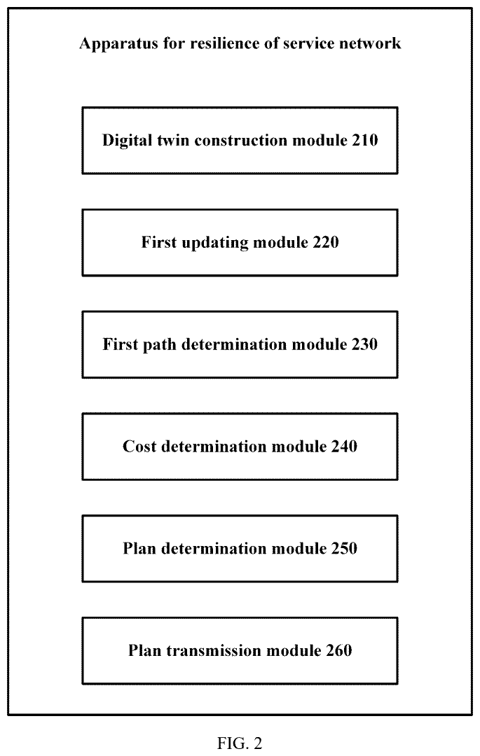

FIG. 2 is a structural block diagram of an apparatus for resilience of a service network according to an embodiment of the disclosure.

As shown in FIG. 2, the apparatus for resilience of the service network may include:
a digital twin construction module 210, configured to construct a corresponding digital twin in a service operation platform based on node states of respective nodes in the service network, link states of links among the respective nodes, and entity states of entities related to the respective nodes;
a first updating module 220, configured to update the digital twin based on the node states of the respective nodes in the service network, the link states of the links among the respective nodes, and the entity states of the entities related to the respective nodes in a case where the service network changes in structure;
a first path determination module 230, configured to determine a plurality of potentially available paths that have not served target demand and meet the target demand based on the updated digital twin;
a cost determination module 240, configured to determine third costs for respective potentially available paths based on first costs for respective nodes in the respective potentially available paths to be changed from failure to being available and second costs for respective links in the respective potentially available paths to be changed from interruption to being available;
a plan determination module 250, configured to determine a path enabling plan among the plurality of potentially available paths based on budget cost of the target demand; and
a plan transmission module 260, configured to transmit the path enabling plan to the service network corresponding to the digital twin, so that the service network provides corresponding services for the target demand according to the path enabling plan.

In an embodiment, the plan determining module includes:
a path ranking unit, configured to rank the plurality of potentially available paths based on the third costs for the respective potentially available paths;
a plan determination unit, configured to calculate a total cost of a sequence of potentially available paths one by one from a potentially available path with a lowest cost based on a result of ranking the plurality of potentially available paths until the total cost of the sequence of potentially available paths is less than the budget cost, and determine the path enabling plan of the digital twin based on the sequence of potentially available path when a sum of the total costs of the sequence of potentially available paths and a third cost of a next potentially available path is greater than the budget cost.

In an embodiment, the apparatus further includes:
a second updating module, configured to update the digital twin based on the node states of the respective nodes, the link states of respective node links, and the entity states of the respective entities in the service network in a case where node performance of the service network is abnormal;
a second path determination module, configured to determine a plurality of existing available paths that have served the target demand and meet the target demand based on the updated digital twin;
a sequence determination module, configured to combine the plurality of existing available paths based on node loads of the respective nodes in the updated digital twin to obtain a plurality of sequences of existing available paths;
a sequence simulation module, configured to perform a simulation test of service operation for respective sequences of existing available paths based on the updated digital twins to obtain response performance of the respective sequences of existing available paths;
an operation scheme determination module, configured to determine a target service operation scheme in the respective sequences of existing available paths based on the response performance of the respective sequences of existing available paths; and
a scheme transmission module, configured to transmit the target service operation scheme to the service network corresponding to the digital twin, so that the service network provides corresponding service for the target demand according to the target service operation scheme.

In an embodiment, the operation scheme determination module includes:
a quality loss calculation unit, configured to determine quality losses of respective nodes in the respective sequences of existing available paths based on the response performance of the respective sequences of existing available paths;
an operation loss calculation unit, configured to weight and sum the quality losses of the respective nodes in the respective sequences of existing available paths respectively based on weights of the respective nodes in the respective sequences of existing available paths to obtain operation losses of the respective sequences of existing available paths; and
a scheme selection unit, configured to determine the target service operation scheme in the respective sequences of existing available paths based on the operation losses of the respective sequences of existing available paths.

In an embodiment, the operation scheme determination module further includes:
a principal component analysis unit, configured to perform principal component analysis on respective nodes in an existing available path to obtain feature values of the respective nodes in the existing available path; and
a node weight determination unit, configured to determine weights of the respective nodes in the existing available path based on feature values of the respective nodes in the existing available path.

In an embodiment, the scheme selection unit is specifically configured to:
determine a sequence of existing available paths with a smallest operation loss among the respective sequences of existing available paths as the target service operation scheme, based on the operation losses of the respective sequences of existing available paths.

Description of corresponding steps in the above method embodiment can be referred for description of specific functions and examples of respective modules and sub-modules of the system in the embodiment of the disclosure, which is not repeatedly described herein.

In the technical scheme of the disclosure, acquisition, storage, application and the like of personal information of users all comply with the provisions of relevant laws and regulations, and do not violate public order and good customs.

According to an embodiment of the disclosure, a system and a readable storage medium are further provided in the disclosure.

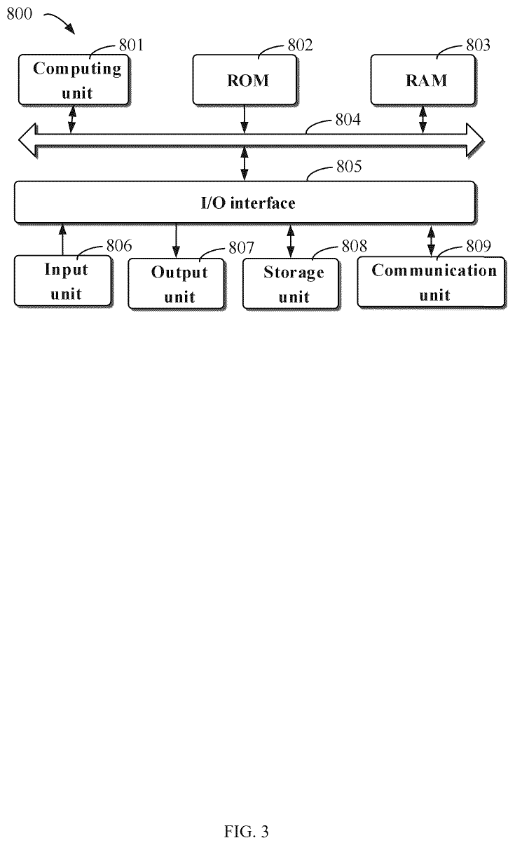

FIG. 3 shows a schematic block diagram of an example electronic device 800 that can be used to implement the embodiments of the present disclosure. The electronic device is intended to encompass various forms of digital computers, such as laptop computers, desktop computers, workstations, personal digital assistants, servers, blade servers, mainframe computers, and other suitable computers. The electronic device can also represent various forms of mobile devices, such as personal digital processing, cellular phones, smart phones, wearable devices and other similar computing devices. The components, connections and relationships thereof, and functions thereof shown herein are only taken as examples, and are not intended to limit implementation of the present disclosure described and/or claimed herein.

As shown in FIG. 3, the device 800 includes a computing unit 801, which can perform various appropriate actions and processes according to a computer program stored in a read only memory (ROM) 802 or a computer program loaded from a storage unit 808 into a random access memory (RAM) 803. Various programs and data required for operations of the device 800 can also be stored in the RAM 803. The computing unit 801, the ROM 802, and the RAM 803 are connected to each other through a bus 804. An Input/output (I/O) interface 805 is also connected to the bus 804.

A number of components in the device 800 are connected to the I/O interface 805, including an input unit 806, such as a keyboard, a mouse, etc; an output unit 807, such as various types of displays, speakers, etc; a storage unit 808, such as a magnetic disk, an optical disk, etc; and a communication unit 809, such as a network card, a modem, a wireless communication transceiver, etc. The communication unit 809 allows the device 800 to exchange information/data with other devices through a computer network such as the Internet and/or various telecommunication networks.

The computing unit 801 can be various general-purpose and/or special-purpose processing components with processing and computing capabilities. Some examples of the computing unit 801 include, but are not limited to, a central processing unit (CPU), a graphics processing unit (GPU), various dedicated artificial intelligence (AI) computing chips, various computing units running machine learning model algorithms, a digital signal processor (DSP), and any suitable processor, controller, microcontroller, etc. The computing unit 801 executes the various methods and processes described above, such as the method for resilience of the service network. For example, in some embodiments, the method for resilience of the service network can be implemented as a computer software program tangibly embodied in a machine-readable medium, such as the storage unit 808. In some embodiments, part or all of the computer program can be loaded into and/or installed on the device 800 via the ROM 802 and/or the communication unit 809. When the computer program is loaded into the RAM 803 and executed by the computing unit 801, one or more steps of the method for resilience of the service network described above can be executed. Alternatively, in other embodiments, the computing unit 801 may be configured to execute the method for resilience of the service network by any other suitable means (for example, by means of firmware).

It should be understood that steps can be reordered, added, or deleted using various forms of processes shown above. For example, steps described in the present disclosure can be executed in parallel, sequentially or in a different order, so long as desired results of technical solutions disclosed in the present disclosure can be achieved, which is not limited herein.

The above implementations do not constitute limitations on protection scope of the present disclosure. It should be understood by those skilled in the art that various modifications, combinations, subcombinations and substitutions can be made according to design requirements and other factors. Any modification, equivalent substitution, improvement, etc. made within the principle of the present disclosure be encompassed within the protection scope of this disclosure.

What is claimed is:

1. A method for resilience of a service network, comprising:
constructing a corresponding digital twin in a service operation platform based on node states of respective nodes in the service network, link states of links among the respective nodes, and entity states of entities related to the respective nodes;
updating the digital twin based on the node states of the respective nodes in the service network, the link states of the links among the respective nodes, and the entity states of the entities related to the respective nodes in a case where the service network changes in structure;
determining a plurality of potentially available paths that have not served target demand and meet the target demand based on the updated digital twin;
determining third costs for respective potentially available paths based on first costs for respective nodes in the respective potentially available paths to be changed from failure to being available and second costs for respective links in the respective potentially available paths to be changed from interruption to being available;
determining a path enabling plan among the plurality of potentially available paths based on budget cost of the target demand, comprising: ranking the plurality of potentially available paths based on the third costs for the respective potentially available paths; calculating a total cost of a sequence of potentially available paths one by one from a potentially available path with a lowest cost based on a result of ranking the plurality of potentially available paths until the total cost of the sequence of potentially available paths is less than the budget cost, and determining the path enabling plan of the digital twin based on the sequence of potentially available path when a sum of the total cost of the sequence of potentially available paths and a third cost of a next potentially available path is greater than the budget cost; and
transmitting the path enabling plan to the service network corresponding to the digital twin, so that the service network provides corresponding services for the target demand according to the path enabling plan.

2. The method for resilience of the service network according to claim 1, further comprising:
updating the digital twin based on the node states of the respective nodes, the link states of respective node links, and the entity states of the respective entities in the service network in a case where node performance of the service network is abnormal;
determining a plurality of existing available paths that have served the target demand and meet the target demand based on the updated digital twin;
combining the plurality of existing available paths based on node loads of the respective nodes in the updated digital twin to obtain a plurality of sequences of existing available paths;
performing a simulation test of service operation for respective sequences of existing available paths based on the updated digital twins to obtain response performance of the respective sequences of existing available paths;
determining a target service operation scheme in the respective sequences of existing available paths based on the response performance of the respective sequences of existing available paths; and
transmitting the target service operation scheme to the service network corresponding to the digital twin, so that the service network provides corresponding service for the target demand according to the target service operation scheme.

3. The method for resilience of the service network according to claim 2, wherein the determining the target service operation scheme in the respective sequences of existing available paths based on the response performance of the respective sequences of existing available paths comprises:
determining quality losses of respective nodes in the respective sequences of existing available paths based on the response performance of the respective sequences of existing available paths;
weighting and summing the quality losses of the respective nodes in the respective sequences of existing available paths respectively based on weights of the respective nodes in the respective sequences of existing available paths to obtain operation losses of the respective sequences of existing available paths; and
determining the target service operation scheme in the respective sequences of existing available paths based on the operation losses of the respective sequences of existing available paths.

4. The method for resilience of the service network according to claim 3, further comprising:
performing principal component analysis on respective nodes in an existing available path to obtain feature values of the respective nodes in the existing available path; and
determining weights of the respective nodes in the existing available path based on feature values of the respective nodes in the existing available path.

5. The method for resilience of the service network according to claim 3, wherein the determining the target service operation scheme in the respective sequences of existing available paths based on the response performance of the respective sequences of existing available paths comprises:
determining a sequence of existing available paths with a smallest operation loss among the respective sequences of existing available paths as the target service operation scheme, based on the operation losses of the respective sequences of existing available paths.

6. An apparatus for resilience of a service network, comprising:
a digital twin construction module, configured to construct a corresponding digital twin in a service operation platform based on node states of respective nodes in the service network, link states of links among the respective nodes, and entity states of entities related to the respective nodes;
a first updating module, configured to update the digital twin based on the node states of the respective nodes in the service network, the link states of the links among the respective nodes, and the entity states of the entities related to the respective nodes in a case where the service network changes in structure;
a first path determination module, configured to determine a plurality of potentially available paths that have not served target demand and meet the target demand based on the updated digital twin;
a cost determination module, configured to determine third costs for respective potentially available paths based on first costs for respective nodes in the respective potentially available paths to be changed from failure to being available and second costs for respective links in the respective potentially available paths to be changed from interruption to being available;
a plan determination module, configured to determine a path enabling plan among the plurality of potentially available paths based on budget cost of the target demand; and
a plan transmission module, configured to transmit the path enabling plan to the service network corresponding to the digital twin, so that the service network provides corresponding services for the target demand according to the path enabling plan;
wherein the plan determining module comprises:
a path ranking unit, configured to rank the plurality of potentially available paths based on the third costs for the respective potentially available paths;
a plan determination unit, configured to calculate a total cost of a sequence of potentially available paths one by one from a potentially available path with a lowest cost based on a result of ranking the plurality of potentially available paths until the total cost of the sequence of potentially available paths is less than the budget cost, and determine the path enabling plan of the digital twin based on the sequence of potentially available path when a sum of the total costs of the sequence of potentially available paths and a third cost of a next potentially available path is greater than the budget cost.

7. An electronic device, comprising:
at least one processor; and
a memory communicatively connected with the at least one processor;
wherein the memory is with instructions executable by the at least one processor, and the instructions are executed by the at least one processor to enable the at least one processor to execute the method of claim 1.

8. A non-transitory computer readable storage medium with computer instructions stored thereon, wherein the computer instructions are configured to cause a computer to execute the method of claim 1.
